(19) United States
(12) Patent Application Publication
(10) Pub. No.: US 2008/0163056 A1
(43) Pub. Date: Jul. 3, 2008

(54) METHOD AND APPARATUS FOR PROVIDING A GRAPHICAL REPRESENTATION OF CONTENT

(76) Inventor: Thibaut Lamadon, Boston, MA (US)

Correspondence Address: THORNE & HALAJIAN;APPLIED TECHNOLOGY CENTER, 111 WEST MAIN STREET, BAY SHORE, NY, 11706, US

(21) Appl. No.: 11/617,016

(22) Filed: Dec. 28, 2006

(51) Int. Cl. G06F 3/00

(52) U.S. Cl. 715/716; 715/840

(57) ABSTRACT

A technique is provided for identifying user accessible content items, organizing the content items by characteristics of the content items and providing a graphical representation of the content items to the user based on the characteristics. A path may be traced within the graph and a playlist of the content items may be provided based on a proximity of the representations of each of the content items to the traced path. The path may have a starting point and content items positioned closer along the path to the starting point may be provided higher up on the playlist than content items positioned farther along the path from the starting point. The content items may be rendered in an order determined by the order of the content items provided on the playlist.

### FIELD OF THE PRESENT SYSTEM

The present system relates to a method and apparatus for visualization of content attributes and a use of the visualization to assist in creating a content playlist.

### BACKGROUND OF THE PRESENT SYSTEM

Content rendering systems have existed for quite some time. Systems for playing digital content have existed since at least 1982 when the compact disc (CD) and CD player was released. Shortly thereafter, systems where provided that enabled a user-selection of the order of playing the CD content. With the advent of software applications running on personal computers, visual tools for choosing the order of playing content became prevalent.

The majority of these systems use a visualization in a form of a list of content titles, such as song titles, and a drag-and-drop interface to assist the user in ordering the playing of the content. Other systems attempt to provide music playlist with or without user interaction. U.S. Pat. No. 6,933,433, titled “Method For Producing Playlist For Personalized Music Stations And For Transmitting Songs On Such Playlists” incorporated herein as if set out in its entirety, is a automated attempt to choose the songs wherein a user assigns artist block ratings related to groupings such as genre. The artist block ratings are utilized to produce an artist rating that determines a number of times that an artist appears on a list from which artists are randomly selected to determine songs for inclusion on a playlist. Once the artist block ratings are assigned, this automated system utilizes no user intervention for production of the playlist. U.S. Pat. No. 6,880,132, titled “Method and Apparatus for Arranging and Displaying Files Or Folders in a Three-dimensional Body” incorporated herein as if set out in its entirety, assumes a hierarchical organization of songs and provides a three-dimensional body having surfaces that are utilized for representing artists, content, and playlists. U.S. Pat. No. 6,748,395, titled “System and Method for Dynamic Playlist of Media” incorporated herein as if set out in its entirety, relies upon sonic characteristics of the music to classify the music and thereby, generate a playlist. U.S. Pat. No. 6,446,080 titled “Method for Creating, Modifying, and Playing a Custom Playlist, Saved as a Virtual CD, to be Played by a Digital Audio/Visual Actuator Device” incorporated herein as if set out in its entirety, utilizes a textual listing of the available songs to enable manual or automated selection of the songs for creating a playlist. U.S. Pat. No. 6,243,725 titled “List Building System” incorporated herein as if set out in its entirety, utilizes a textual listing of the available songs to enable manual selection of the songs for creating a playlist. None of these systems provides a simple graphical environment for eliciting user input for determination of a content playlist.

### SUMMARY OF THE PRESENT SYSTEM

It is an object of the present system to overcome disadvantages and/or make improvements in the prior art.

The present system includes a system, method and device for providing a graphical representation of content items based on characteristics associated with the content items. In accordance with an embodiment of the present system, a technique is provided for identifying user accessible content items, organizing the content items by characteristics of the content items and providing a visual representation of the content items to a user based on the characteristics. In a further embodiment, the user is enabled to create a playlist of content items by providing a gesture within a user interface (UI), such as a graphical user interface (GUI).

A device for graphically depicting a content library may be arranged to retrieve content items and associated data describing characteristics of each one of the content items, identify at least one attribute of the characteristics, and graph representations of each of the content items in at least two-dimensions based on the identified at least one attribute. In one embodiment, the graph may be provided as a two-dimensional graph and each of at least two attributes may be provided along a different one of an axis of the graph. The graphical representation may be browsed by a user to identify characteristics associated with a particular one of the content items.

In one embodiment, the attribute may be determined by providing a listing of attributes to the user and enabling the user to select the attribute from the provided list of attributes. In another embodiment, the attribute may be identified utilizing principle component analysis of the characteristics of the content items.

The device may be arranged to enable tracing a path within the graph to provide a playlist of the content items based on a proximity of the representations of each of the content items to the traced path. The path may have a starting point and content items positioned closer to the starting point may be provided higher up on the playlist than content items positioned farther from the starting point. The content items may be rendered in an order determined by the playlist.

In one embodiment, the device may be arranged to enable searching for a rendering device suitable to render the content items. A number of content items provided on the playlist may be determined by a desired length of time required to render the playlist which may have an effect of adjusting the proximity of content items to the path utilized for identifying content items. In an alternate embodiment, the device may be arranged to enable the user to provide a total number of content items desired on the list which will adjust the proximity of content items to the path utilized for identifying content items for the playlist.

### BRIEF DESCRIPTION OF THE DRAWINGS:

The invention is explained in further detail, and by way of example, with reference to the accompanying drawings wherein:

FIG. 1 shows a system in accordance with an embodiment of the present system;

FIG. 2 shows a process flow diagram in accordance with an embodiment of the present system;

FIG. 3 shows a flow diagram including details of the READ LIBRARY and ORGANIZE acts depicted in FIG. 2 in accordance with an embodiment of the present system;

FIG. 4 shows a flow diagram including details of the DISPLAY act depicted in FIG. 2 in accordance with an embodiment of the present system;

FIG. 5 shows an illustrative example of a graphing of music content items within a graphical user interface (GUI) in accordance with an embodiment of the present system;

FIG. 6 shows a further presentation of content items in accordance with an embodiment of the present system;

FIG. 7 shows a GUI presentation of content items in accordance with an embodiment of the present system;

FIG. 8 shows a flow diagram including details of the PLAY act depicted in FIG. 2 in accordance with an embodiment of the present system; and

FIG. 9 shows a device in accordance with an embodiment of the present system.

### DETAILED DESCRIPTION OF THE PRESENT SYSTEM:

The following are descriptions of illustrative embodiments that when taken in conjunction with the following drawings will demonstrate the above noted features and advantages, as well as further ones. In the following description, for purposes of explanation rather than limitation, illustrative details are set forth such as architecture, interfaces, techniques, element attributes, etc. However, it will be apparent to those of ordinary skill in the art that other embodiments that depart from these details would still be understood to be within the scope of the appended claims. Moreover, for the purpose of clarity, detailed descriptions of well known devices, circuits, modeling tools, analysis techniques and methods are omitted so as not to obscure the description of the present system. It should be expressly understood that the drawings are included for illustrative purposes and do not represent the scope of the present system.

For purposes of simplifying a description of the present system, the term rendering and formatives thereof as utilized herein refer to providing content, such as digital media, such that it may be perceived by at least one user sense, such as a sense of sight and/or a sense of hearing. A playlist, content item playlist, etc., refers to a selection (e.g., such as a listing) of content items for rendering. The playlist may be ordered for sequential rendering or may be rendered in another order, such as a random order that differs from a sequential listing of the playlist. A path is intended to refer to one or more user provided line portions entered via a user input device interacting with a user interface.

The system and method described herein address problems in prior art systems. In accordance with an embodiment of the present system, a device and technique is provided for identifying user accessible content items, organizing the content items by characteristics of the content items and providing a visual representation of the content items to the user based on the characteristics. In a further embodiment, the user is enabled to create a playlist of content items by providing a gesture within a user interface (UI), such as a graphical user interface (GUI).

The GUI may be provided by an application running on a processor, such as part of a computer system. The visual environment may be displayed by the processor on a display device and a user may be provided with an input device to influence events or images depicted on the display device. GUI's present visual images which describe various visual metaphors of an operating system, an application, etc. implemented on the processor/computer.

In operation, a user typically moves a user-controlled object, such as a cursor or pointer, across a computer screen and onto other displayed objects or screen regions, and then inputs a command to execute a given selection or operation. Other applications or visual environments also may provide user-controlled objects such as a cursor for selection and manipulation of depicted objects in a multi-dimensional (e.g., two-dimensional) space.

The user interaction with and manipulation of the computer environment is achieved using any of a variety of types of human-processor interface devices that are operationally coupled to the processor controlling the displayed environment. A common interface device for GUI's is a mouse, trackball, keyboard, touch-sensitive display, etc. For example, a mouse may be moved by a user in a planar workspace to move a visual object, such as a cursor, depicted on a two-dimensional display surface in a direct mapping between the position of the user manipulation and the depicted position of the cursor. This is typically known as position control, where the motion of the depicted object directly correlates to motion of the user manipulation.

An example of such a GUI in accordance with an embodiment of the present system is a GUI for interaction within a content item selection program that may be user invoked, such as to enable a user to create, edit, and/or select a content item playlist. In accordance with a further embodiment, the user may be enabled within the GUI to create a content item playlist of any duration that may correspond to a user selectable mood or moods. The GUI may provide an environment for creating a playlist in accordance with an embodiment of the present system. To facilitate manipulation (e.g., creation, editing, etc.) of the playlist, the GUI may provide different views that are directed to different portions of the manipulation process. For example, the GUI may present a typical UI including a windowing environment and as such, may include menu items, pull-down menu items, etc. that are typical of those provided in a windowing environment, such as may be represented within a Windows™ Operating System graphical UI as provided by Microsoft Corporation. The objects and sections of the GUI may be navigated utilizing a user input device, such as a mouse, trackball and/or other suitable user input. Further, the user input may be utilized for making selections within the GUI such as by selection of menu items, radio buttons and other common interaction paradigms as understood by a person of ordinary skill in the art.

Similar interfaces may be provided by a device having a touch sensitive screen that is operated on by an input device such as a finger of a user or other input device such as a stylus. In this environment, a cursor may or may not be provided since a location of selection is directly determined by the location of interaction with the touch sensitive screen. Although the GUI utilized for supporting touch sensitive inputs may be somewhat different than a GUI that is utilized for supporting, for example, a computer mouse input, however, for purposes of the present system, the operation is similar. Accordingly, for purposes of simplifying the foregoing description, the interaction discussed is intended to apply to either of these systems or others that may be suitably applied.

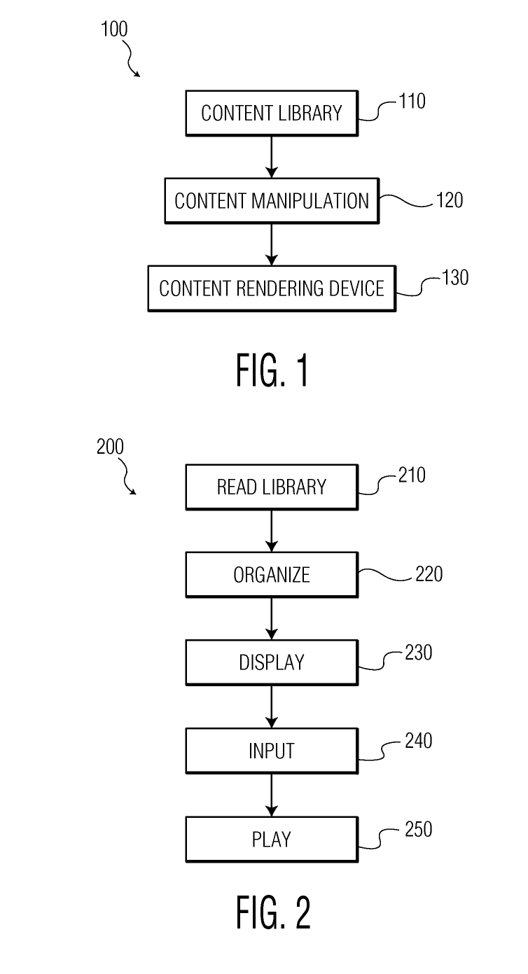

FIG. 1 shows a system 100 in accordance with an embodiment of the present system. The system 100 includes a content library 110, a content manipulation portion 120 and a content rendering device 130. The content library 110 may be provided by either of a local or remote storage device as described further herein below. The content library may include content items and data. The content items may include audio content, video content, audio/visual content, image content, textual content, and/or other content that may be rendered to a user. The content manipulation portion 120 is operationally coupled to the content library 110 to enable retrieval of the content items (e.g., songs, movies, pictures, etc.) and the data that describes characteristics of the content items of the content library 110. The characteristics may be associated with the individual items of the content library, such as associated metadata. Characteristics may include rendering length of content item, year of production, genre, beats-per-minute, tone, tempo, rating, frequency of selection, and/or any other characteristics and/or combinations thereof, that may be utilized to suitably describe characteristics of the content items. For example, a characteristic of the content item may be provided as a combination of characteristics (from the content, such as beat, tempo, etc. and/or provided by a user or group of users), such as a straight linear combination, for example as may be provided by a partial coherence analysis (PCA) of characteristics to identify a linear relationship between two or more characteristics after an influence of a further characteristic (e.g., a third characteristic) is removed. A characteristic may also be provided as a relation of a content item to another content item, such as how often one content item is selected for rendering following a previously rendered content item. Numerous other characteristics and/or combinations of characteristics would readily occur to a person of ordinary skill in the art and may be readily applied.

In accordance with the present system, the content manipulation portion 120 may graphically represent the content items to the user and may be utilized to create a playlist of content items. Subsequent to processing by the playlist manipulation portion 120, content identified in a resulting playlist may be provided to the content rendering device 130 for rendering.

FIG. 2 shows a process flow diagram 200 in accordance with an embodiment of the present system. In operation, during a READ LIBRARY act 210, a content library is accessed to extract content items and/or content characteristics associated with the content items, such as metadata. The content items are ordered during an ORGANIZE act 220 which orders each content item according to selectable and/or pre-specified criteria related to the content characteristics. Thereafter, a DISPLAY act 230 plots each content item on a multi-dimensional graph wherein the number of dimensions of the graph are related the number of criteria utilized during the ORGANIZE act 220. For example, in an application wherein two criteria are utilized to organize the content during the ORGANIZE act 220, a two-dimensional graph may be utilized to plot the content items. As described above, one or more of the criteria may includes combinations of criteria (e.g., characteristics), such as by PCA. During an INPUT act 240, a user is enabled to browse the content items and may specify a playlist utilizing a gesture, such as manipulating an input device to trace a path through the graph. In another embodiment, the path may be generated based on a previously provided playlist, such as stored locally or accessible over a network, to enable a visualization of the playlist. The PLAY act 250 may create a playlist, where one is not provided, and/or forward a request to render the content identified on the playlist to a content rendering device.

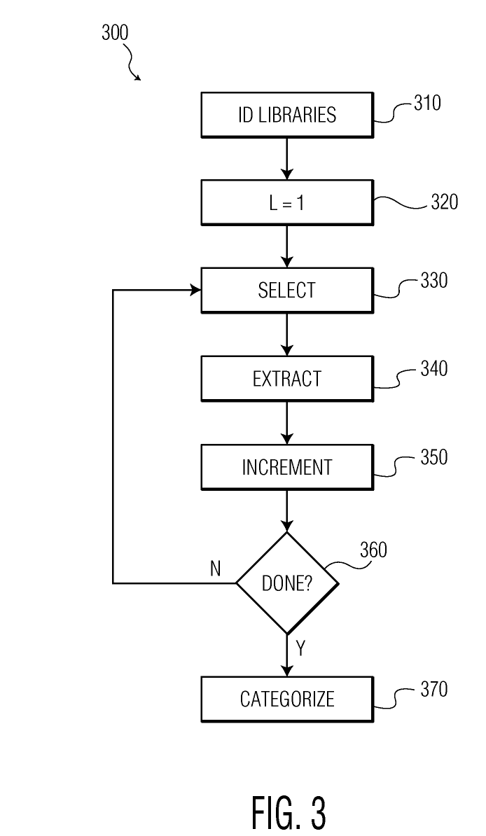

FIG. 3 shows a flow diagram 300 including details of the READ LIBRARY and ORGANIZE acts depicted in FIG. 2 in accordance with an embodiment of the present system. Content libraries that are accessible to the present system are identified and a variable (e.g., “N”) is set to a number of libraries identified during act 310. A library counter (e.g., “L”) is set to 1 to identify to the present system that a first library is being scrutinized (act 320). Subsequently, during act 330, library L is selected and the library is scrutinized such that the content items characteristics, such as associated characteristics (e.g., metadata), and/or combinations of characteristics, etc. (herein generally referred to simply as characteristics), are extracted from library L during act 340. After the content items and characteristics are extracted, the library counter L is incremented (e.g., L=L+1) during act 350. A test is performed (act 360) to determine whether all the identified libraries have been scrutinized (e.g., test whether L>N). In a case wherein all the identified libraries have not been scrutinized (e.g., L>N is false), control returns to act 330 wherein a next library is selected.

In a case wherein all the identified libraries have been scrutinized (e.g., L>N is true), control moves to a content categorizing act 370 wherein the content items are organized according to content characteristics (e.g., attributes of the content characteristics) that may be determined from the content characteristics, may be pre-determined, or may be determined or selectable by the user. For example, in one embodiment in accordance with the present system, the user may be provided with a list of attributes describing the characteristics of the content items that may be utilized to organize the content items. For example, the user may be enabled within a user interface to select two or more attributes for organizing the content items. For auditory content items such as music content items, provided attributes may include characteristic categories such as tempo, rhythm, genre, date of creation (e.g., year, month, day), rendering length, content type (e.g., audio, visual, audio/visual, etc.), user ratings, group ratings, frequency of content item selection, such as from direct selection rendering, etc. For audio/visual content items, attributes such as genre, date of creation, scene cut rate, rendering length, user rating, etc., may be readily applied. Other attributes for auditory content or other content would readily occur to a person of ordinary skill in the art, including combinations of the above or other attributes, and are intended to be encompassed by the present system.

In another embodiment, attributes may be automatically determined by the system based on an analysis to determine what attributes may provide a greatest amount of variance within the content items. As may be readily appreciated, techniques such as principle component analysis (PCA) may be applied in accordance with an embodiment of the present system to identify two or more significant dimensions of attributes as the automatically determined attributes. In accordance with one embodiment, the most significant dimensions may be determined as those dimensions that provide a greatest variance (e.g., spread within a coordinate space determined by the attributes) among the content items. In another embodiment, different portions of a single attribute may be utilized for both of the vertical and horizontal coordinates. For example, an attribute such as genre may be utilized wherein the positioning of a content item within the plot is based on an alphabetical ordering of a first and second letter of the corresponding genre of the content item for determining a vertical (e.g., first letter of genre) and horizontal (e.g., second letter of genre) plot position. Attributes may also be simply provided directly by the user. Other systems for determining attributes would readily occur to a person of ordinary skill in the art and are within the scope of the present system.

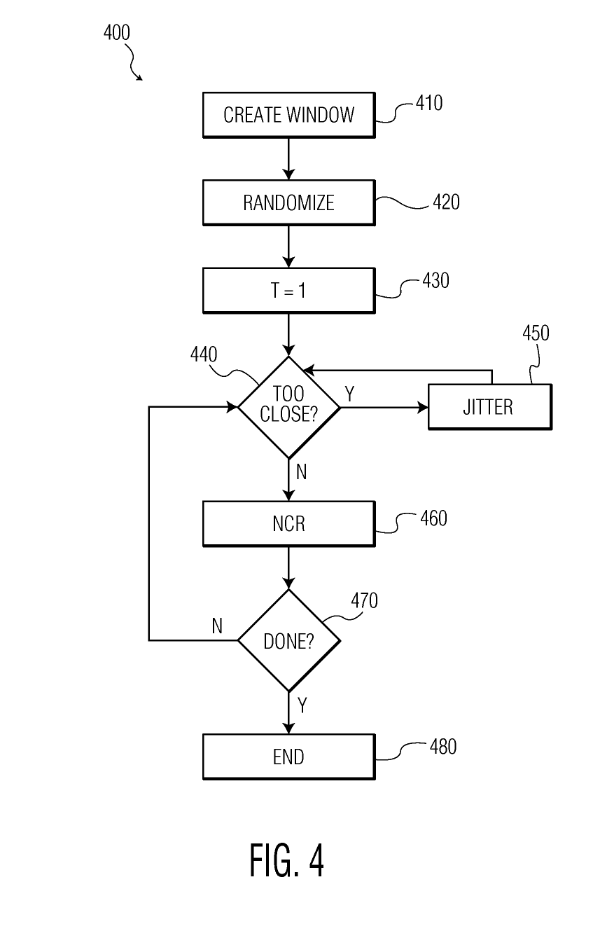

FIG. 4 shows a flow diagram 400 including details of the DISPLAY act depicted in FIG. 2 in accordance with an embodiment of the present system. During act 410, a display window is positioned and sized on a display screen. During act 420, content items retrieved during process 300 may be randomly ordered or selected for positioning on the display screen. This process may be utilized to determine an order of selecting content items for positioning, while the positioning is determined by the attributes selected. Naturally, in another embodiment, another ordering or selection process for positioning may be utilized. For example, content items may be ordered in the order previously retrieved, may be ordered alphabetically based on content title, etc. In another embodiment, other systems for ordering and/or selecting the content items may be readily applied. During act 430, a counter is initialized to a first content item. During act 440, a current content item (e.g., the first ordered content item from act 430 to start, and thereafter, each subsequent ordered/selected content item) is positioned on the display screen based on the attributes selected during the categorizing act 370 illustratively depicted in FIG. 3. For example, for an attribute of increasing time of content creation plotted as a vertical coordinate (e.g., of the content items) and an attribute of increasing tempo plotted as a horizontal coordinate, an audio content item, such as music, is positioned (e.g., plotted) within the display window based on the characteristics associated (e.g., metadata) with that particular content item. The content item may be represented on the plot as a single coordinate point (e.g., a dot) or other graphical representation, such as an icon representative of the content item. In one embodiment, a shape of the content item representation may convey information about the content item. For example, a larger representation of a content item as compared to another content item may identify a content item that is rated higher as compared to the other content item. As discussed above, a rating may be associated with the content item as a characteristic of the content item, and as such, may be a rating provided or determined from user selection of a frequency of rendering selection of the content item. Further, the rating may be provided as a global rating, such as from a plurality of users that select the content item for rendering, purchase, etc. In a further embodiment, the rating may be a combination of ratings directly, or with a weighting system wherein certain sources of rating data are weighted differently than other sources of rating data. In this embodiment, a rating of the user may be weighted more heavily than a rating acquired from a third party group and thereby, have a larger effect on the overall rating. As may be readily appreciated by a person of ordinary skill in the art, the size and/or shape of the displayed content item representation may convey other information associated with the content item. As such, other representations of the content items may be readily applied.

In accordance with an embodiment of the present system, it may be desirable that each individual content item is discernable (e.g., positionally, visually, etc.) from each other content item depicted in the display window. Accordingly, during act 440, the positioning of the content item may be checked to determine whether the positioning (e.g., coordinates) of the content item is less than a given minimum distance from a previously plotted content item. The minimum distance may be determined based on one or more of a total number of content items, an available area in the display window, a predetermined minimum distance, etc. For example, a given minimum distance between content items in either of the vertical or horizontal axis may be between 0.005% and 0.5% of the display area available, such as 0.1% of the display area. For example, for a 5 units (e.g., inches, centimeters, etc.) by 5 units display area, it may be desirable that each content item depicted in the plot be no closer than 0.005 units. In one embodiment, this number may be determined based on a total number of content items that are retrieved for plotting. In any event, if it is determined that the plot of the current content item is too close to a previously plotted content item, a JITTER procedure may be initiated during act 450 to move the coordinates of the current content item by an amount (e.g., randomly determined small amount) along the vertical and/or horizontal axis (e.g., X and Y axis) to move the plot of the current content item away from the plot of the close previously plotted content item. This process may be continued (e.g., act 440 may be repeated) until it is determined that the plots are spaced sufficiently apart. Naturally in one embodiment, act 450 may be performed only once followed by act 460 as described further herein.

In a case wherein the current plot of the content item is determined to not be too close to another content item during act 440, the content item counter is incremented during act 460 (e.g., counter T=T+1) and a check is performed during act 470 to determine if all the content items have been plotted (e.g., T>total number of content items). If all the content items have been plotted, then the process ends during act 480, otherwise act 440 may be repeated and a next content item may be plotted and the process described above may be repeated (e.g., acts 440, 450, etc.).

The graphical presentation (e.g., plotting) of the content items based one or more attributes in accordance with the present system provides the user with an opportunity to appreciate a content collection in a way that heretofore is not provided by prior solutions. By selection and/or variation of attributes, the user may be provided with an insight into available content items that was not previously discernable. For example, a clustering of content items within the graphing may provide insight into linking characteristics of content items that otherwise may appear to be unrelated. For example, a genre attribute distribution of jazz music content items and classical music content items may appear unrelated and based on an alphabetically ordered genre attribute, corresponding content items may be positioned in separate portions of the plot. However, a different plotting based on a beats per minute attribute, may position portions of these content items in close proximity. As may be readily appreciated, other selections of attribute(s) may provide other insight into relationships between the content items that may not have been previously apparent.

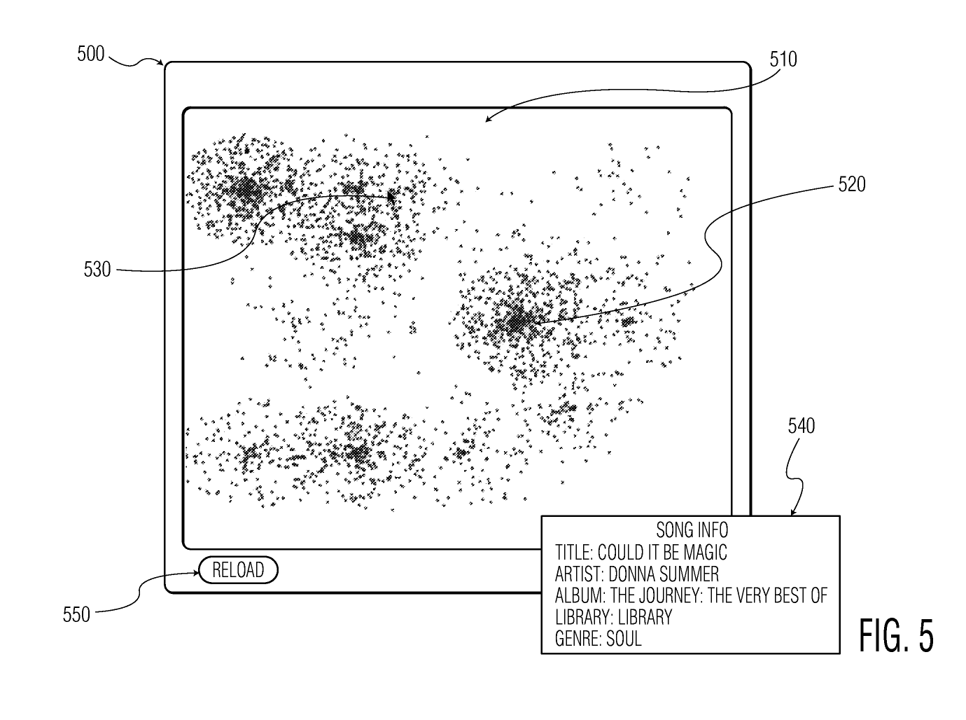

FIG. 5 shows an illustrative example of a graphing 500 of music content items 520 within a graphical user interface (GUI) in accordance with an embodiment of the present system. As shown, a display window 510 is provided for the plotting of the content items. A cursor 530 may be positioned in proximity to a given content item to enable an identification of the content item and related metadata within a display area 540. In this way, a user may browse the plot of the content items to be provided with an indication of how the attribute(s) selected for creating the plot, has positioned the content items within the plot. Similar information may be provided in a GUI supporting a touch sensitive screen by similar positioning of a selection device (e.g., finger, stylus, etc.) with regard to a depicted content item. Selection of a “reload” radio button as would be appreciated by a person of ordinary skill in the art may provide the user an opportunity to change an attribute selection should a different plotting of content items be desired (e.g., a change of the result of act 370).

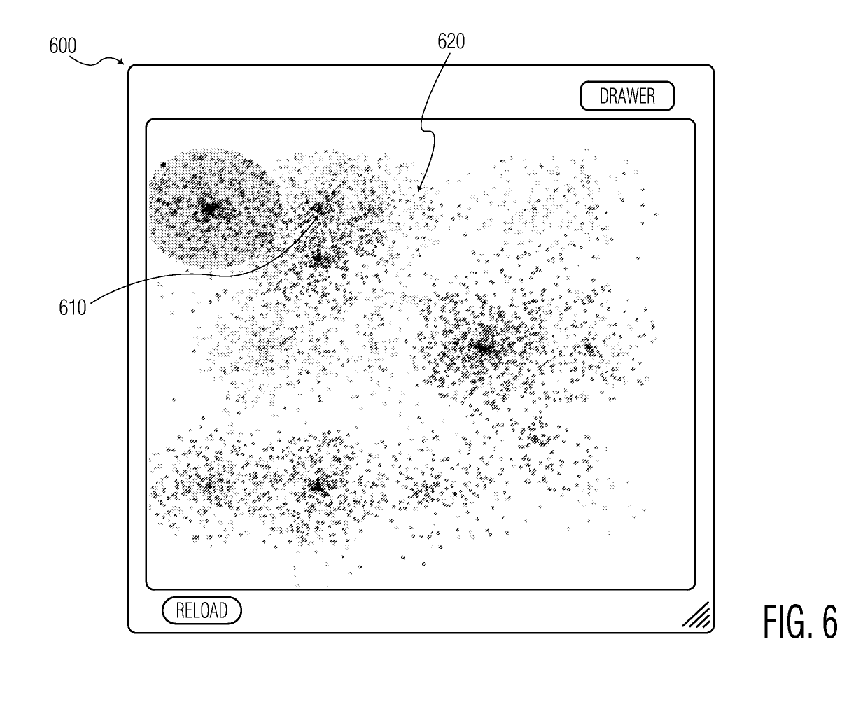

FIG. 6 shows a further presentation 600 of content items in accordance with an embodiment of the present system. In this embodiment, two content collections (e.g., libraries) are overlaid on top of each other within a single representation. Content items 610, 620 may be depicted as originating from different content collections by having different shading, colors, object representations, size of objects, and/or other visual characteristics of the depicted content items to distinguish the content items of each collection. In this way, the visual presentation of content items in one collection, may be utilized to identify one or more content items from another collection that may be of interest to the user. For example, an overlay of a depiction of a friends music content items over the user's music content items may enable a discovery of music content items from the friend's collection that may be of interest to the user.

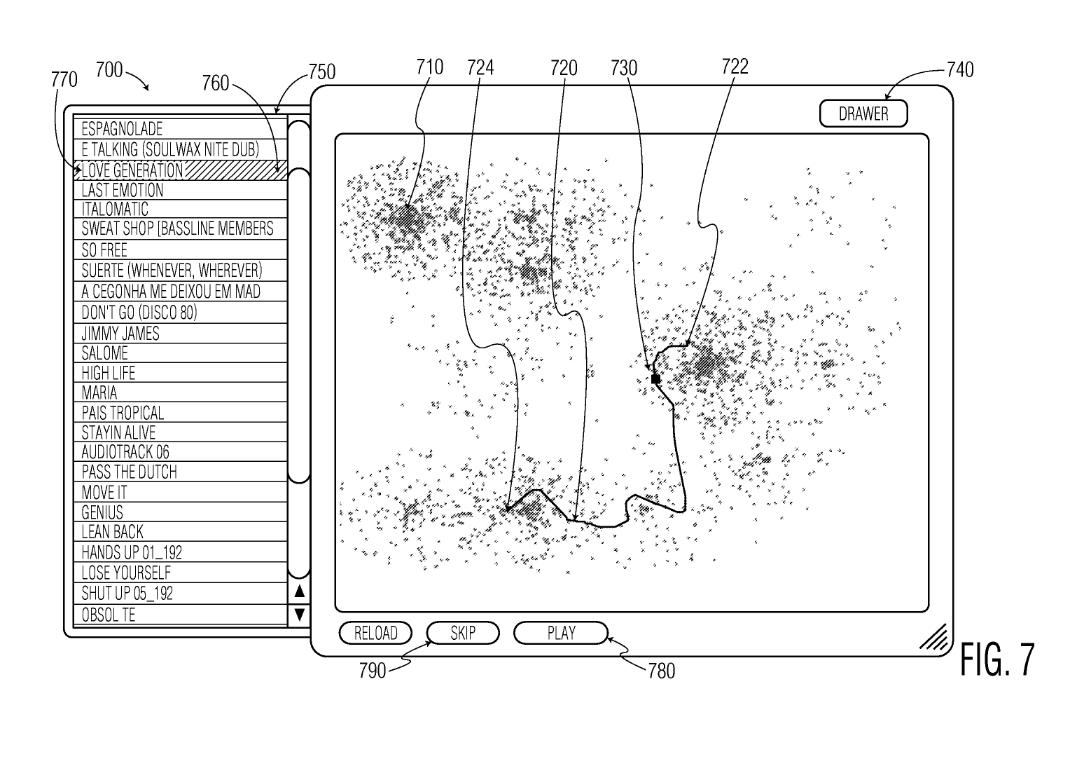

FIG. 7 shows a GUI presentation 700 of content items 710 in accordance with an embodiment of the present system. In this embodiment, the presentation 700 is provided to enable a user determined playlist of content items. In accordance with this embodiment, a user-provided gesture within the GUI facilitated by a user input device, such as a mouse, etc., is utilized to trace a path 720 through the content items 710. The path 720, including an origin 722 and end-point 724, is utilized in accordance with an embodiment of the present system to create a playlist of content items. For example, in one embodiment, content items within a determined, predetermined or selectable distance from the path 720 may be automatically selected for inclusion on the playlist. An order of the playlist may be determined by the direction of the path. For example, content items positioned closer along the path to the origin 722 of the path 720 may be ordered in the playlist prior to content items positioned relatively further along the path from the origin 722. In this way, a content item playlist may be readily determined by the user using a simple graphical presentation of the content items and potentially as little as a single gesture, such as a single tracing of the path 720.

In one embodiment, by setting a proximity of the content items to the path 720 required for inclusion on the playlist, together with the length and positioning of the path 720, the rendering length of the playlist is directly determined. In another embodiment, the user may select a desired rendering time for a playlist (e.g., 1-hour music playlist) which together with a given path, will dynamically determine how close content items are required to the path for inclusion on the playlist to achieve the desired rendering time. For example, for a given path 720 and a desired rendering time of one hour, content items would be selected relatively further from the path to achieve the desired rendering time than if the desired rendering time where set to be one-half an hour. Conversely, for a given path 720 and a desired rendering time of one hour, content items would be selected relatively closer to the path to achieve the desired rendering time than if the desired rendering time where selected to be two hours. In another embodiment, a user may select a number of content items desired for the playlist regardless of rendering time which again may automatically determine a minimum distance from the path for inclusion on the playlist as may be readily appreciated. Other variations would readily occur to a person of ordinary skill in the art and are intended to be within the scope of the present system.

In accordance with a further embodiment, selection of a “drawer” radio button 740 may provide a further portion 750 of the GUI 700 wherein the content items of the playlist are listed, such as in an order provided on the playlist. Selection of a particular portion of the path 720 as illustrated by an indication 730, such as may be provided by positioning a cursor or other selection system at the particular portion and/or left-clicking, right-clicking, etc., within the GUI as may be readily appreciated, may select a position of the playlist to be depicted in the further portion 750 such that content items in proximity to the indication 730 are depicted in the further portion 750. In one embodiment, a content item 770 that is in closest proximity to the indication 730 may be provided with an indication 760, such as a shading, coloring, etc., to visually indicate that the shaded content item 770 is closest to the indication 730.

As will be described further herein, a “play” radio button 780 may be utilized to begin rendering of the content items. In one embodiment, the indication 730 and/or the indication 760 may depict a portion of the path/playlist that is currently being rendered. In one embodiment, selection of a “skip” radio button 790 may skip rendering of a current or next content item. Positioning of the indication 730 through the user input device may determine which content item is rendered in response to the play radio button 780. Next playing content items may be content items that are next along the path 720 (e.g., the content items that are next further along the path from the origin 722) after the previously rendered content item.

In a further embodiment, the path may be rendered by the system based on a provided playlist. In this embodiment, the rendering of the path together with the positioning of the content items on the graph, may provide insight into the content items of the playlist that are not discernable from a mere listing of the content items. For example, the path of the content items may provide an insight into the ordering of the playlist to enable a reordering by the user that follows a different progression (e.g., based on the characteristic(s) selected fog the graph) of the content items. In this embodiment, a content item from the provided playlist that is determined to not be available from the library may be depicted by a suitable indication that provides this information (e.g., a shaded indication).

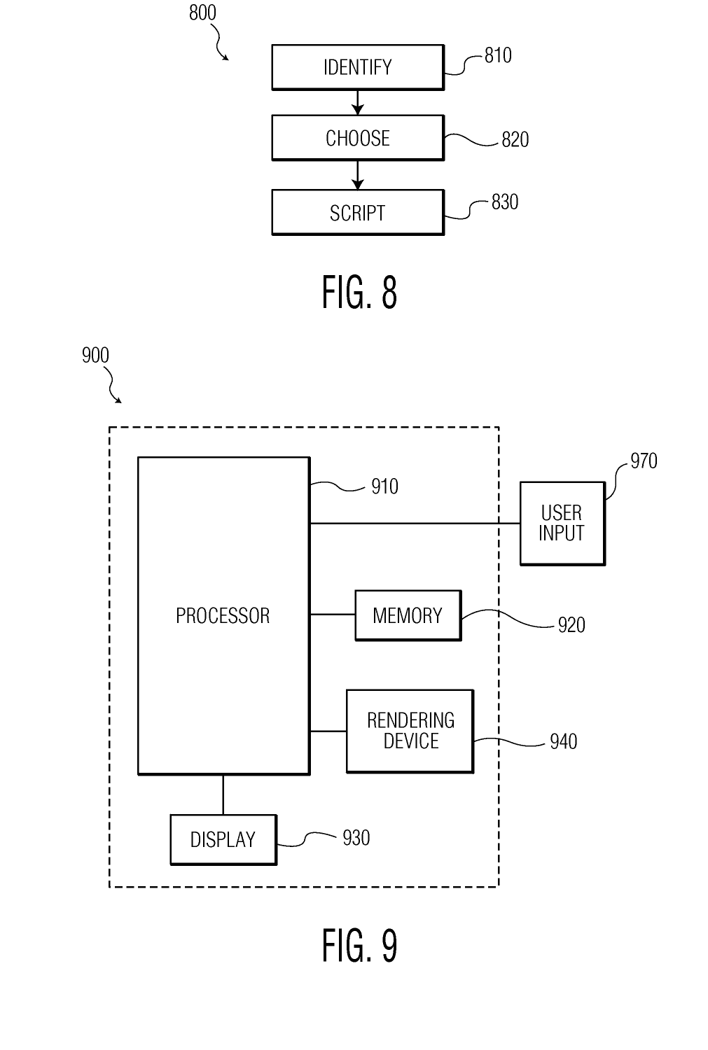

FIG. 8 shows a flow diagram 800 including details of the PLAY act depicted in FIG. 2 in accordance with an embodiment of the present system. During act 810, the system may identify content rendering devices (e.g., media players) that are available to the present system. For example, a given system may have different rendering devices for different types of content. During act 820, an appropriate rendering device is selected and content items from the generated playlist are forwarded for rendering by the rendering device during act 830.

FIG. 9 shows a device 900 in accordance with an embodiment of the present system. The device has a processor 910 operationally coupled to a memory 920, a display 930, a user input device 970 and one or more rendering devices 940. The memory 920 may be any type of device for storing programming application data, such as to support a user interface (e.g., GUI), as well as other data, such as content items, content libraries, content characteristic descriptions (e.g., metadata), etc. The programming application data and other data are received by the processor 910 for configuring the processor 910 to perform operation acts in accordance with the present system. The operation acts may include controlling the display 930 to display content such as the GUIs 500, 600, 700 and/or controlling the rendering device to render content in accordance with a generated playlist. The user input 970 may include a keyboard, mouse, trackball, accelerometer or other device, such as a touch sensitive display, or motion tracking device (e.g., Computer Vision based motion tracking) which may be stand alone or be a part of a system, such as part of a personal computer, personal digital assistant, content rendering device (e.g., MP3 player) or display device for communicating with the processor 910 via any type of link, such as a wired or wireless link. The user input device 970 is operable for interacting with the processor 910 including interaction within a paradigm of a GUI, selection of content, content libraries, attributes and/or other elements of the present system. Clearly the processor 910, memory 920, display 930, user input device 970, and/or content rendering device 940 may all or partly be a portion of a computer system or other device, such as a dedicated content rendering device (e.g., portable music player).

The methods of the present system are particularly suited to be carried out by a computer software program, such program containing modules corresponding to one or more of the individual steps or acts described and/or envisioned by the present system. Such program, content items, libraries, etc. may of course be embodied in a computer-readable medium, such as an integrated chip, a peripheral device or memory, such as the memory 920 and/or other memory coupled to the processor 910.

The memory 920 may be any recordable medium (e.g., RAM, ROM, removable memory, CD-ROM, hard drives, DVD, floppy disks or memory cards) or may be a transmission medium (e.g., a network comprising fiber-optics, the world-wide web, cables, a wireless channel using time-division multiple access, code-division multiple access, or other radio-frequency or wireless communication channel). Any medium known or developed that may store and/or transmit information suitable for use with a computer system may be used as the memory 920.

Additional memories may also be used. The memory 920, and/or any other memories may be long-term, short-term, or a combination of long-term and short-term memories. These memories may configure the processor 910 to render the GUIs and implement the methods, operational acts, and functions disclosed herein. The memories may be distributed or local and the processor 910, where additional processors may be provided, may also be distributed or may be singular. For example, the GUI may be embedded in a web-based application that is wholely or partially provided by a remote processor. The memories may be implemented as electrical, magnetic or optical memory, or any combination of these or other types of storage devices. Moreover, the term “memory” should be construed broadly enough to encompass any information able to be read from or written to an address in the addressable space accessible by a processor. With this definition, information on a network is still within memory 920, for instance, because the processor 910 may retrieve the information from the network for operation in accordance with the present system.

The processor 910 is capable of providing control signals and/or performing operations in response to input signals from the user input device 970 and executing instructions stored in the memory 920. The processor 910 may be an application-specific and/or general-use integrated circuit(s). Further, the processor 910 may be a dedicated processor for performing in accordance with the present system and/or may be a general-purpose processor wherein only one of many functions operates for performing in accordance with the present system. The processor 910 may operate utilizing a program portion, multiple program segments, and/or may be a hardware device utilizing a dedicated or multi-purpose integrated circuit. Further, in a distributed system, portions of an operation may be performed on one device with data generated therefrom being transferred to one or more further devices. For example, a playlist may be generated on one device with results from the playlist being transferred to a further device, such as a rendering device. In this embodiment, a playlist may be generated on a device such as a computer with the playlist thereafter being exported to a rendering device such as an audio rendering device (e.g., MP3 player, AAC player, etc.). In this embodiment, processors and memories may be distributed between at least these two devices.

Of course, it is to be appreciated that any one of the above embodiments or processes may be combined with one or more other embodiments and/or processes or be separated and/or performed amongst separate devices or device portions in accordance with the present system.

Finally, the above-discussion is intended to be merely illustrative of the present system and should not be construed as limiting the appended claims to any particular embodiment or group of embodiments. Thus, while the present system has been described with reference to exemplary embodiments, it should also be appreciated that numerous modifications and alternative embodiments may be devised by those having ordinary skill in the art without departing from the broader and intended spirit and scope of the present system as set forth in the claims that follow. In addition, the section headings included herein are intended to facilitate a review but are not intended to limit the scope of the present system. Accordingly, the specification and drawings are to be regarded in an illustrative manner and are not intended to limit the scope of the appended claims.

In interpreting the appended claims, it should be understood that:

a) the word “comprising” does not exclude the presence of other elements or acts than those listed in a given claim;

b) the word “a” or “an” preceding an element does not exclude the presence of a plurality of such elements;

c) any reference signs in the claims do not limit their scope;

d) several “means” may be represented by the same item or hardware or software implemented structure or function;

e) any of the disclosed elements may be comprised of hardware portions (e.g., including discrete and integrated electronic circuitry), software portions (e.g., computer programming), and any combination thereof;

f) hardware portions may be comprised of one or both of analog and digital portions;

g) any of the disclosed devices or portions thereof may be combined together or separated into further portions unless specifically stated otherwise;

h) no specific sequence of acts or steps is intended to be required unless specifically indicated; and

i) the term “plurality of” an element includes two or more of the claimed element, and does not imply any particular range of number of elements; that is, a plurality of elements may be as few as two elements, and may include an immeasurable number of elements.

What is claimed is:

1. A method of graphically depicting a content library comprising acts of:
retrieving content items and associated data describing characteristics of each one of the content items;
identifying at least one attribute of the characteristics;
graphing representations of each of the content items in at least two-dimensions based on the identified at least one attribute.

2. The method of claim 1, wherein the at least one attribute is at least two attributes.

3. The method of claim 2, wherein the act of graphing comprises an act of graphing each of the at least two attributes along a different one of the at least two-dimensions.

4. The method of claim 1, comprising an act of browsing the graphical representation to identify characteristics associated with a particular one of the content items.

5. The method of claim 1, wherein the act of identifying at least one attribute comprises the acts of:
providing a plurality of attributes to a user; and
selecting the at least one attribute from the provided plurality of attributes.

6. The method of claim 1, wherein the act of identifying at least one attribute comprises the act of analyzing the characteristics utilizing principle component analysis to identify two attributes for the graphing act.

7. The method of claim 1, comprising acts of:
tracing a path within the graph; and
providing a playlist of the content items based on a proximity of the representations of each of the content items to the traced path.

8. The method of claim 7, wherein the path has a starting point and content items positioned closer to the starting point occur higher up on the playlist than content items positioned farther from the starting point.

9. The method of claim 7, comprising an act of rendering the content items in an order determined by the playlist.

10. The method of claim 9, comprising an act of searching for a rendering device suitable to render the content items, wherein the act of rendering the content items is provided based on the searching act.

11. The method of claim 7, comprising an act of receiving a selection of a length of time desired by a user for rendering the content items, wherein the act of providing a playlist comprises an act of adjusting the proximity utilized for identifying content items based on the received length of time.

12. The method of claim 7, comprising an act of receiving a total number of content items desired by a user for rendering, wherein the act of providing a playlist comprises an act of adjusting the proximity utilized for identifying content items based on the received total number of content items.

13. An application embodied on a computer readable medium arranged to graphically depict a content library, the application comprising:
a portion arranged to retrieve content items and associated data describing characteristics of each one of the content items;
a portion arranged to identify at least one attribute of the characteristics; and
a portion arranged to graph representations of each of the content items in at least two-dimensions based on the identified at least one attribute.

14. The application of claim 13, wherein the portion arranged to graph is arranged to graph each of at least two attributes along a different one of at least two-dimensions.

15. The application of claim 13, comprising:
a portion arranged to allow a user to trace a path within the graph; and
a portion arranged to provide a playlist of the content items based on a proximity of the representations of each of the content items to the traced path.

16. The application of claim 15, wherein the path has a starting point and the portion arranged to provide a playlist is arranged to provide content items positioned closer to the starting point higher up on the playlist than content items positioned farther from the starting point.

17. The application of claim 15, comprising a portion arranged to render the content items in an order determined by the playlist.

18. A device for graphically depicting a content library, the device comprising:
a display; and
a processor operationally coupled to the display, wherein the processor is arranged to:
retrieve content items and associated data describing characteristics of each one of the content items;
identify at least one attribute of the characteristics; and
graph representations on the display of each of the content items in at least two-dimensions based on the identified at least one attribute.

19. The device of claim 18, wherein the processor is arranged to:
allow a user to trace a path within the graph; and
provide a playlist of the content items based on a proximity of the representations of each of the content items to the traced path.

20. The device of claim 18, wherein the processor is arranged to render the content items in an order determined by the playlist.
